(19) United States
(12) Patent Application Publication
(10) Pub. No.: US 2018/0203716 A1
(43) Pub. Date: Jul. 19, 2018

(54) SYSTEMS AND METHODS FOR SOFTWARE EVENT SIGNALING OF STATE CHANGES OF REMOTE HARDWARE DEVICES FOR VIRTUAL DESKTOP INFRASTRUCTURE ENVIRONMENTS

(71) Applicant: Citrix Systems, Inc., Fort Lauderdale, FL (US)

(72) Inventors: Venu Gopal Nathani, Parkland, FL (US); Gabriel Carrejo, Fort Lauderdale, FL (US); Owen A. Smith, Cambridge (GB)

(21) Appl. No.: 15/405,480

(22) Filed: Jan. 13, 2017

(51) Int. Cl. G06F 9/455; G06F 9/44

(52) U.S. Cl. CPC G06F 9/45558; G06F 2009/4557; G06F 9/4443

(57) ABSTRACT

Systems and methods for automatically changing an Operational Mode (“OM”) of a Virtual Machine (“VM”). The methods comprise: detecting an OM change of a Computing Device (“CD”) from a first OM to a second OM in response to (a) a coupling or decoupling of an external device to/from the CD or (b) a reception of a user-software interaction for changing the OM; communicating information indicating CD's OM change from first software of the CD directly to a Virtual Desktop Agent (“VDA”) of the VM; performing first operations by the VDA to determine whether a third OM in which the VM is currently operating is the same as the second OM in which CD is currently operating; and performing second operations by the VDA to transform the third OM of the VM to the second OM when a determination is made that the third OM is different than the second OM.

### BACKGROUND

### Statement of the Technical Field

The present document relates to computer systems. More particularly, the present document relates to systems and methods for software event signaling of state changes of remote hardware devices for virtual desktop infrastructure environments.

### Description of the Related Art

Desktop mode is a Graphical User Interface (“GUI”) environment for Windows operating systems. In Desktop mode, a user can quickly access applications and services via input devices (e.g., a keyboard and a mouse). Also, each program operates in a distinct window that can be moved around, resized and minimized.

Tablet mode is a new Microsoft enhanced user experience functionality introduced in the Windows 10 operating system for small form factor personal computing devices (e.g., a Microsoft Surface Pro, an ASUS Transformer or a Lenovo Miix) which allows users to use the personal computing devices like Tablets. Tablet mode can be selectively activated via a user software interaction or automatically activated when a personal computing device is detached from its base or dock. In Tablet mode, the Start menu is displayed in full-screen, and the Desktop becomes unavailable. In effect, the starting point for all user activities is the Start screen. By default, the Start screen displays the tiles that the user pinned to it. The Windows 10 operating system optimizes the look and behavior of the applications when it is running in a tablet mode. In this regard, applications open full screen, giving the user more space to work in. Additionally, two applications can be used side-by-side in Tablet mode.

In order to exit Tablet mode in Windows 10 and go back to Desktop mode, a user must interact with the personal computing device. On a device with touch, the user must flick from the right margin of the screen to the left margin of the screen to bring up an Action Center. Then, the user taps the Tablet mode button of the Action Center. The Tablet mode button can also be used to once again enable Tablet mode at a later time.

An Original Equipment Manufacturer (“OEM”) of the 2-in-1 personal computing device can report the state of the 2-in-1 personal computing device by generating a hardware signal to Windows 10/Windows Server 2016 operating systems to toggle between Desktop mode and Tablet mode. For example, if a user detaches a keyboard from a 2-in-1 personal computing device, then the Desktop mode is automatically converted into the Tablet mode as discussed above. The 2-in-1 personal computing device's mode is automatically converted back into the Desktop mode when the user reattaches the keyboard thereto. The same switching between Tablet mode and Desktop mode experience can be provided seamlessly on Windows 10/Windows Server 2016 virtual desktop environment based on the client device and device state.

### SUMMARY

The present document concerns implementing systems and methods for automatically changing an operational mode of a Virtual Machine (“VM”). The methods comprise: detecting an operational mode change of a computing device from a first operational mode to a second operational mode in response to (a) a coupling or decoupling of an external device (e.g., an input device) to/from the computing device or (b) a reception of a user-software interaction for changing the operational mode; communicating first information indicating the computing device's operational mode change from first software (e.g., client software) of the computing device directly to a Virtual Desktop Agent (“VDA”) of the VM; performing first operations by the VDA to determine whether a third operational mode in which the VM is currently operating is the same as the second operational mode in which the computing device is currently operating; and performing second operations by the VDA to transform the third operational mode of the VM to the second operational mode when a determination is made that the third operational mode is different than the second operational mode. The VDA may also perform third operations to transform the VM's operational mode in response to a connection of another computing device, that is of a type different than that of the computing device, to the Virtual Desktion Infrastructure (“VDI”) during a VM session.

In some scenarios, the computing device is a client computing device and the VM is running on a remote server. The client computing device may include, but is not limited to, a 2-in-1 device. The first operational mode is a Desktop mode and the second operational mode is a Tablet mode, or vice versa. The first software of the computing device comprises client software enabling access to a VDI of the remote server via a network. The VDI allows virtualization software (e.g., virtualization applications) to emulate the computing device's hardware on the remote server.

The present document also concerns implementing systems and methods for automatically changing an operational mode of a VM based on device types. The methods comprise: performing operations by a first computing device of a first device type to establish a VM-based VDI session to the VM running on a remote server; performing operations by a second computing device to connect to the VM during the VM-based VDI session, the second computing device of a second device type different than the first device type of the first computing device; communicating information indicating the second device type from client software of the second computing device directly to a VDA of the VM; and performing operations by the VDA to transform an operational mode of the VM from a first operational mode to a second different operational mode based on the second device type.

The present document further concerns systems comprising first and second computing devices. The first computing device comprises a first electronic circuit programmed to: toggle an operational mode between a first operational mode and a second operational mode in response to (a) a connection of an external device (e.g., an input device) to the first computing device or (b) a reception of a user-software interaction for changing the operational mode; and communicate first information indicating a change in the operational mode directly to a VDA of a VM. The second computing device is remotely located from the first computing device. The second computing device comprises a second electronic circuit programmed to host the VM and make the VM accessible to the first computing device via a network. The VDA determines whether a third operational mode in which the VM is currently operating is the same as the first or second operational mode in which the first computing device is currently operating, and transforms the third operational mode of the VM to the first or second operational mode when a determination is made that the third operational mode is different than the first or second operational mode. The VDA may further transform the VM's operational mode in response to a connection of a third computing device, that is of a type different than that of the first computing device, to the VDI during a VM session

In some scenarios, the first computing device is a client computing device and the second computing device is a server. The client computing device may include, but is not limited to, a 2-in-1 device. The first operational mode is a Desktop mode and the second operational mode is a Tablet mode, or vice versa. The first computing device comprises client software enabling access to a VDI of the remote server. The VDI allows virtualization software to emulate the first computing device's hardware on the remote server.

### BRIEF DESCRIPTION OF THE DRAWINGS

Embodiments will be described with reference to the following drawing figures, in which like numerals represent like items throughout the figures.

FIG. 1 is an illustration of an exemplary hardware architecture for a computing device.

FIG. 2 is an illustration of an exemplary software architecture for a computing device.

FIG. 3 is an illustration of an exemplary system implementing a Virtual Desktop Infrastructure (“VDI”) technique.

FIG. 4 is a flow diagram of an exemplary method for automatically changing an operational mode of a Virtual Machine (“VM”) running on a client computing device.

FIGS. 5A-5C (collectively referred to as “FIG. 5”) is a flow diagram of an exemplary method for automatically changing an operational mode of a VM running on a remote server.

FIG. 6 is a flow diagram of an exemplary method for automatically changing an operational mode of a VM running on a remote server.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout the specification may, but do not necessarily, refer to the same embodiment.

Furthermore, the described features, advantages and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

The term “laptop”, as used herein, refers to a system with a physical keyboard permanently attached that allows a user to always type comfortably. The term “tablet”, as used herein, refers to a system with no physical keyboard available. The term “2-in-1”, as used herein, refers to a system that the user can transform both in a laptop form factor and a tablet form factor (e.g., by removing, flipping or swiveling the keyboard).

The present disclosure concerns systems and methods for software event signaling of state changes of remote hardware devices for virtual desktop infrastructure environments. The present solution provides a software mechanism to toggle between desktop and application modalities based on a computing device operational state. In some scenarios, the methods involve: emulating a Basic Input/Output System (“BIOS”) on a server to enable a guest Operating System (“OS”) running on a 2-in-1 computing device (e.g., a Microsoft Surface Pro, an ASUS Transformer or a Lenovo Miix); detecting a client device change notification on a client device and simulating the same hardware notification on Virtual Desktop Agent (“VDA”); and delivering an experience nearly invisible to the user as the user changes devices and form factors, with universal applications and desktops reacting instantly.

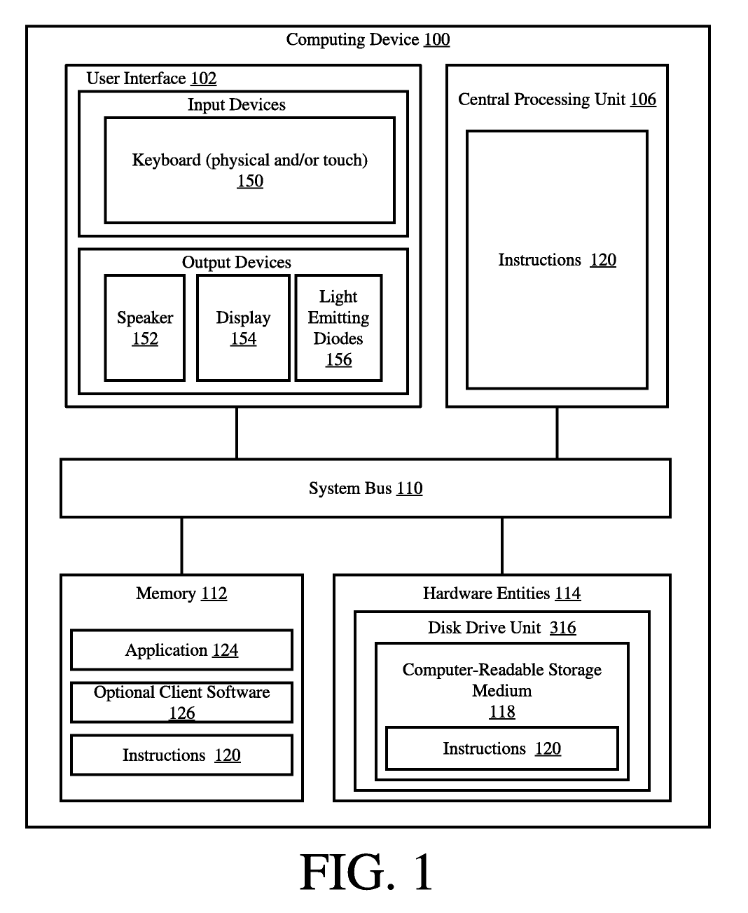

Referring now to FIG. 1, there is provided an illustration of an exemplary architecture for a computing device 100. In some scenarios, the present solution is used in a client-server architecture. Accordingly, the computing device architecture shown in FIG. 1 is sufficient for understanding the particulars of client computing devices and servers.

Computing device 100 may include more or less components than those shown in FIG. 1. However, the components shown are sufficient to disclose an illustrative embodiment implementing the present solution. The hardware architecture of FIG. 1 represents one embodiment of a representative computing device configured to perform software event signaling of state changes of remote hardware devices for virtual desktop infrastructure environments. As such, the computing device 100 of FIG. 1 implements at least a portion of each method described herein.

Some or all the components of the computing device 100 can be implemented as hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to and/or programmed to perform one or more of the methodologies, procedures, or functions described herein.

As shown in FIG. 1, the computing device 100 comprises a user interface 102, a Central Processing Unit (“CPU”) 106, a system bus 110, a memory 112 connected to and accessible by other portions of computing device 100 through system bus 110, and hardware entities 114 connected to system bus 110. The user interface can include input devices and output devices, which facilitate user-software interactions for controlling operations of the computing device 100. The input devices include, but are not limited, a physical and/or touch keyboard 150. The input devices can be connected to the computing device 100 via a wired or wireless connection (e.g., a Bluetooth® connection). The output devices include, but are not limited to, a speaker 152, a display 154, and/or light emitting diodes 156.

At least some of the hardware entities 114 perform actions involving access to and use of memory 112, which can be a Random Access Memory (“RAM”), a disk driver and/or a Compact Disc Read Only Memory (“CD-ROM”). Hardware entities 114 can include a disk drive unit 116 comprising a computer-readable storage medium 118 on which is stored one or more sets of instructions 120 (e.g., software code) configured to implement one or more of the methodologies, procedures, or functions described herein. The instructions 120 can also reside, completely or at least partially, within the memory 112 and/or within the CPU 106 during execution thereof by the computing device 100. The memory 112 and the CPU 106 also can constitute machine-readable media. The term “machine-readable media”, as used here, refers to a single medium or multiple media (e.g., a centralized or distributed database, and/or associated caches and servers) that store the one or more sets of instructions 120. The term “machine-readable media”, as used here, also refers to any medium that is capable of storing, encoding or carrying a set of instructions 120 for execution by the computing device 100 and that cause the computing device 100 to perform any one or more of the methodologies of the present disclosure.

In some scenarios, the hardware entities 114 include an electronic circuit (e.g., a processor) programmed for facilitating software event signaling of state changes of remote hardware devices for virtual desktop infrastructure environments. In this regard, it should be understood that the electronic circuit can access and run applications 124, 126 installed on the computing device 100. In the client-server based scenarios, the client device may be a 2-in-1 device able to access a virtualization environment hosted by the server. Accordingly, the software application 124 is generally operative to facilitate the provision of a 2-in-1 computing device and/or a locally hosted virtualization environment. Client software 126 is generally operative to facilitate access to a remotely hosted virtualization environment (e.g., hosted by a server located in a datacenter). The functions of the software applications 124, 126 will become apparent as the discussion progresses.

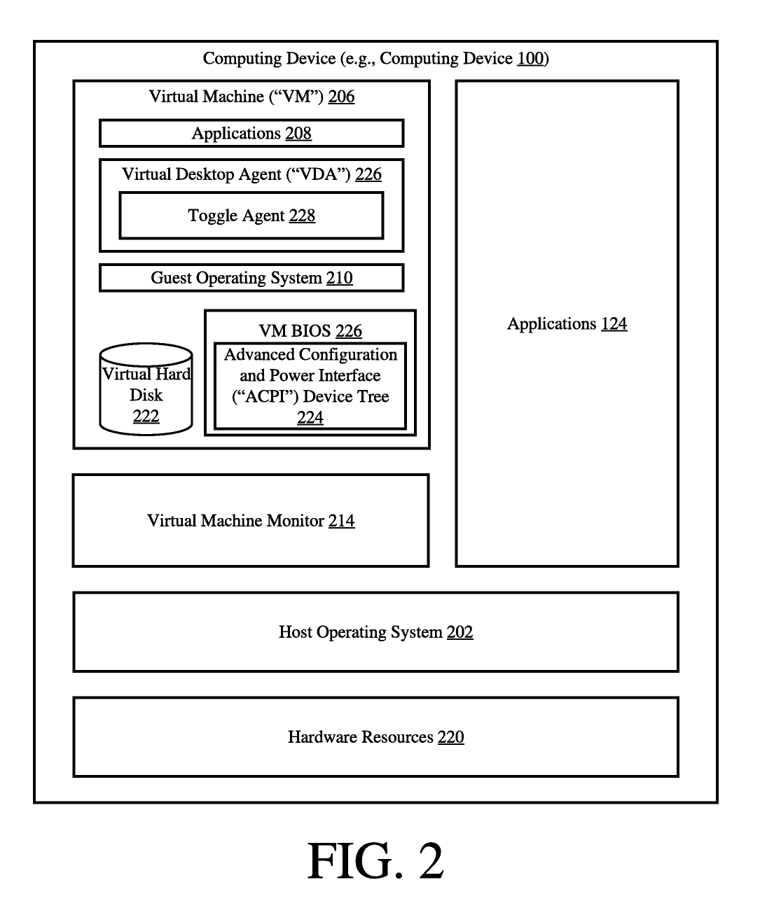

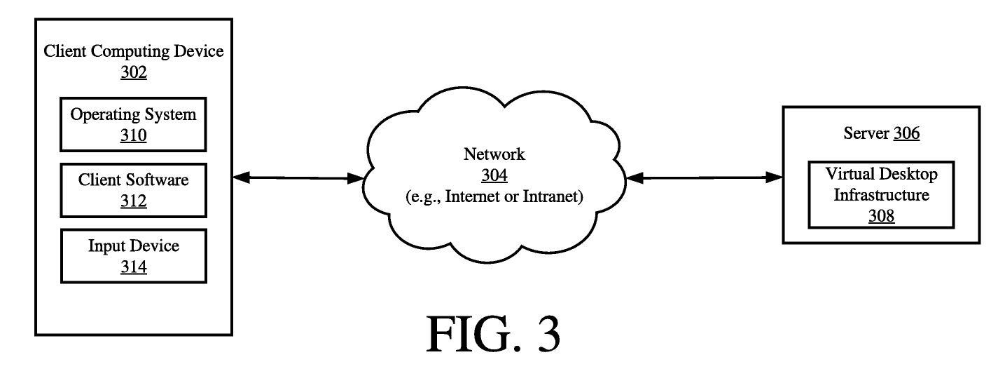

Referring now to FIG. 2, there is provided an illustration of the basic concepts of virtualization environment hosted by a computing device, such as computing device 100 of FIG. 1 and/or a server (e.g., server 306 of FIG. 3 discussed below). As shown in FIG. 2, the computing device runs a general purpose host OS 202 that manages access of one or more software applications (e.g., applications 124, 126 of FIG. 1) to hardware resources 220. In some scenarios, the hardware resources 220 include, but are not limited to, the hardware device 102-156 shown in FIG. 1.

A Virtual Machine Monitor (“VMM”) 214 (or hypervisor) runs on the host computing device and emulates the hardware of a physical system. The host computing device runs the VMM 214 in order to enable the concurrent execution of additional OS instances. From the perspective of the host OS 202, the VMM 214 is an application. The VMM 214 is generally a piece of software that creates at least one guest VM 206 and manages the operation of the virtualized environment on top of the physical host computing device. In this regard, the VMM 214 coordinates instructions to the CPU 106. The VMM 214 validates all the guest-issued CPU instructions and manages any executed code that required additional privileges. The additional OS instance runs on the VM 206.

The VM 206 is a software computer that runs a guest OS 210 (e.g., Windows 10) in an environment that is isolated from the host OS 202. The guest OS 210 hosts its own set of applications 208 and is installed on a virtual hard disk 222. The virtual hard disk 222 is implemented as a file that is stored on a file system accessible to the host computing device 100. From the perspective of the guest OS 210, the virtual hard disk 222 cannot be distinguished from a physical storage medium (e.g., memory 112 of FIG. 1). The virtual hard disk 222 stores a system image containing the complete content and structure of a physical hard disk. Multiple virtual hard disks containing disk images can be attached to the VM 206. The host computing device 100 controls access of the VM 206 to the available hardware resources, such as a physical memory 112 of FIG. 1.

The fully virtualized guest OS 210 requires some emulation of physical hardware before it can start or boot in accordance with a pre-defined booting process. The booting process is controlled by a VM BIOS 226. The VM BIOS 226 comprises a set of instructions that controls booting and input/output operations of the VM 206.

In order to emulate the BIOS, information usually provided by the physical hardware needs to be supplied to the VM BIOS 226. Among the information provided to the VM BIOS 226 is the emulated Advanced Configuration and Power Interface (“ACPI”) device tree 224. The term “device tree”, as used herein, refers to a data structure describing hardware. Each node of the device tree represents a piece of physical hardware. This ACPI device tree 224 can be modified to include additional devices not present on the physical computing device or exclude physical devices that are not desired by the VM 206. The present solution utilizes a virtual ACPI device exposed by the emulated ACPI device tree 224 that is not necessarily present on the physical hardware.

In some scenarios, the computing device is a 2-in-1 computing device running the host OS (e.g., the Windows 10 OS) and having a Desktop/Tablet mode toggle functionality. This toggling is facilitated by a General Purpose Input/Output (“GPIO”) device driver (e.g., a GPIO laptop-or-slate-indicator driver). GPIO device drivers (e.g., such as the GPIO laptop-or-slate-indicator driver) are well known in the art, and therefore will not be described in detail herein. Still, it should be understood that the device driver specifies a hardware form factor to be used in a Desktop mode and/or a Tablet mode. For example, if a GPIO indicator is set to one (1), then the computing device is in a Desktop mode. The Desktop mode is a mode in which: a touch keyboard does not automatically display when the user taps an edit field; and/or a screen auto-rotation is disabled. In contrast, if the GPIO is set to zero (0), then the computing device is in a Tablet mode. The Tablet mode is a mode in which: the touch keyboard automatically displays when a user taps an edit field; and/or the screen auto-rotation is enabled.

In order to facilitate such toggling in the VM 206, a new toggle agent 228 is implemented in the VDA 226. The toggle agent 228 allows a user of the VM 206 to toggle between the Desktop mode and the Tablet mode. In some scenarios, the client software (e.g., client software 126 of FIG. 1) notifies the VM 206 of the operational mode that the computing device is currently in and when the computing device's operational mode is changed.

During initial connection, the client software sends a notification to the VDA 226 indicating the computing device's current operational mode (i.e., whether the computing device is in a Desktop mode or a Tablet mode). The VDA 226 inspects a previous operational mode of the VM 206 and changes the operational mode of the VM 206 if it differs from that specified in the notification received from client software.

For example, if a user of the computing device connects to the VDA 226 while the computing device is in its Tablet mode, then the VDA 226 ensures that the virtual session runs under Tablet mode. If the user decides to change the operational mode of the computing device to Desktop mode, then the VDA 226 performs operations to toggle the VM's operational mode from its Tablet mode to its Desktop mode. With this feature, the user can smoothly cause a change in operational modes of the VM using functions of the underlying computer system.

While the virtual session is connected, if a user changes the operational mode by attaching or detaching a keyboard, then the client software notifies the VDA 226 of the operational mode change. In this regard, it should be noted that: the Desktop mode is automatically converted into the Tablet mode when the keyboard is detached from the computing device; and the personal computing device's operational mode is automatically converted back into the Desktop mode when the user reattaches the keyboard thereto.

In accordance with another example, the computing device comprises a touch screen tablet Personal Computer (“PC”), such as an iPad. If the user of the computing device connects to the VDA 226, then the VDA 226 ensures that the virtual session is running in Tablet mode. While the virtual session is running, if a Bluetooth keyboard is paired so as to convert the computing device's operational mode to the Desktop mode, then the VDA 226 is automatically caused to change the VM's operational mode from the Tablet mode to the Desktop mode. Similarly, if the Bluetooth keyboard is un-paired, then the VM's operational mode is automatically toggled back to Tablet mode.

As noted above, the present solution can be implemented in client-server based systems. In these scenarios, a VDI is employed as shown in FIG. 3. VDIs are well known in the art, and therefore will not be described in detail herein. Still, it should be noted that VDI 308 is generally configured to implement the process of running a user desktop OS within a VM running on a centralized server 306 (which may be located in a datacenter). A client computing device 302 obtains access to the VDI 308 via a network 304 (e.g., the Internet or Intranet). The client computing device 302 includes, but is not limited to, a personal computer, a 2-in-1 device, a desktop computer, a tablet or a smart phone. Each of these listed devices is well known in the art, and therefore will not be described in detail herein. In some scenarios, the client computing device 302 and/or server 306 is/are the same as or substantially similar to the computing device 100 of FIG. 1 and/or FIG. 2. As such, the discussion of computing devices in relation to FIG. 1 and/or FIG. 2 is sufficient for understanding the client computing device 302 and/or server 306 hardware and/or software architectures. In addition to this understanding, it should be understood that the VDI allows the sever 306 virtualization software to emulate the client computing device's 302 hardware on the server 306, and the client computing device's 302 software components 310 and/or 312 to directly communicate with the VDA (e.g., VDA 226 of FIG. 2) of the VM (e.g., VM 206 of FIG. 2) running on the server 306.

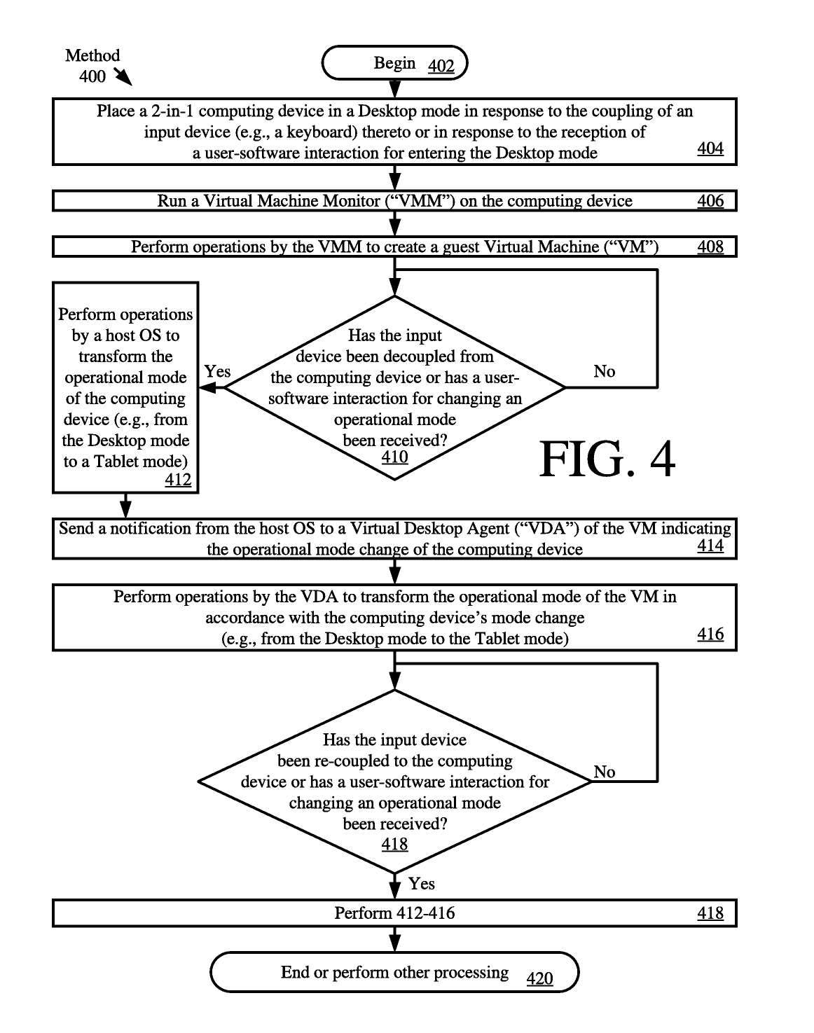

Referring now to FIG. 4, there is provided a flow diagram of an exemplary method 400 for automatically changing an operational mode of a VM (e.g., VM 206 of FIG. 2) running on a computing device (e.g., computing device 100 of FIGS. 1-2, client computing device 302 of FIG. 3, or server 306 of FIG. 3). Method 400 begins with 402 and continues with 404 where a 2-in-1 computing device is placed in a Desktop mode. This can be done in response to the physical or communicative coupling of an input device (e.g., a keyboard 150 of FIG. 1) to the computing device and/or the computing device's reception of a user-software interaction for changing its operational mode.

In next 406, a VMM (e.g., VMM 214 of FIG. 2) is run on the computing device. The VMM performs operations in 408 to create a guest VM (e.g., guest VM 206 of FIG. 2). Thereafter, the computing device determines whether the input device (e.g., a keyboard) has been decoupled therefrom or whether a user-software interaction has been received to change its operational mode (e.g., a drop down menu selection for switching to a Desktop mode or a Tablet mode), as shown by 410. If the input device has not been decoupled from the computing device or the user-software interaction has not been received by the computing device [410:NO], then method 400 repeats 410. In contrast, if the input device has been decoupled from the computing device or the user-software interaction has been received by the computing device [410:YES], then method 400 continues with 412-416.

412-416 involve: performing operations by a host OS (e.g., host OS 202 of FIG. 2) to transform the operational mode of the computing device (e.g., from the Desktop mode to the Tablet mode); sending a notification from the host OS to a VDA (e.g., VDA 226 of FIG. 2) of the VM indicating the operational mode change of the computing device; and performing operations by the VDA to transform the operational mode of the VM in accordance with the computing device's operational mode change.

At some time later, the computing device may determine that the input device has been recoupled thereto or may receive a user-software interaction for once again changing its operational mode, as shown by [418:YES]. In this case, 412-416 are once again performed to change the VM's operational mode from the Tablet mode to the Desktop mode. Subsequently in 420, method 400 ends or other processing is performed.

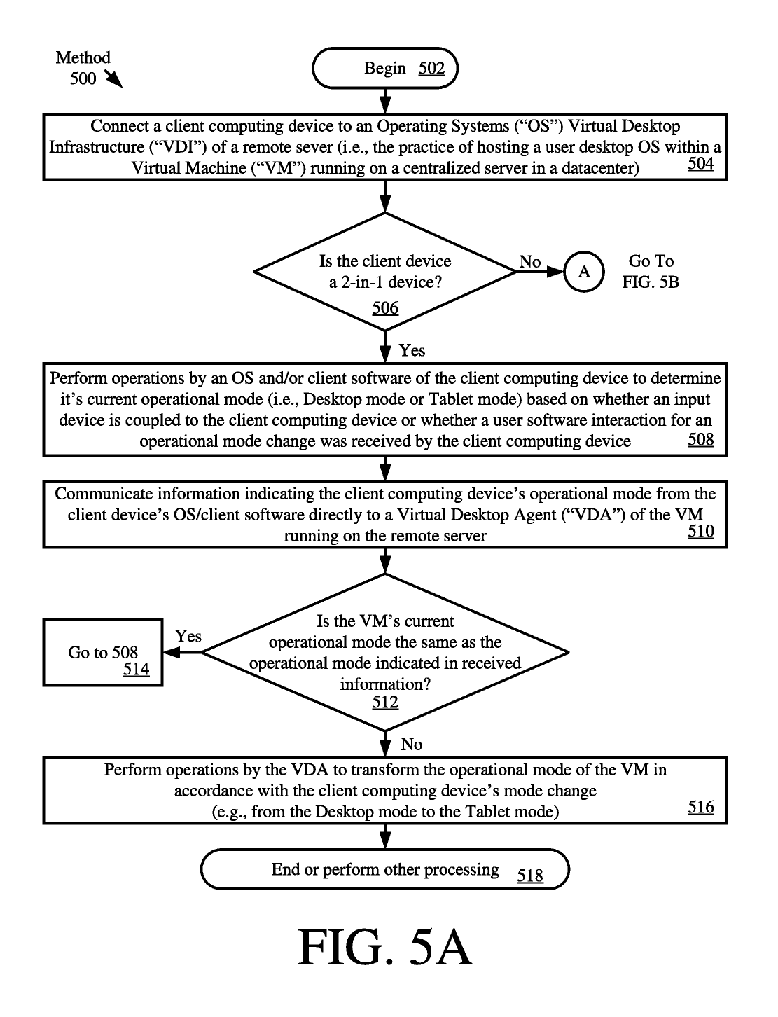

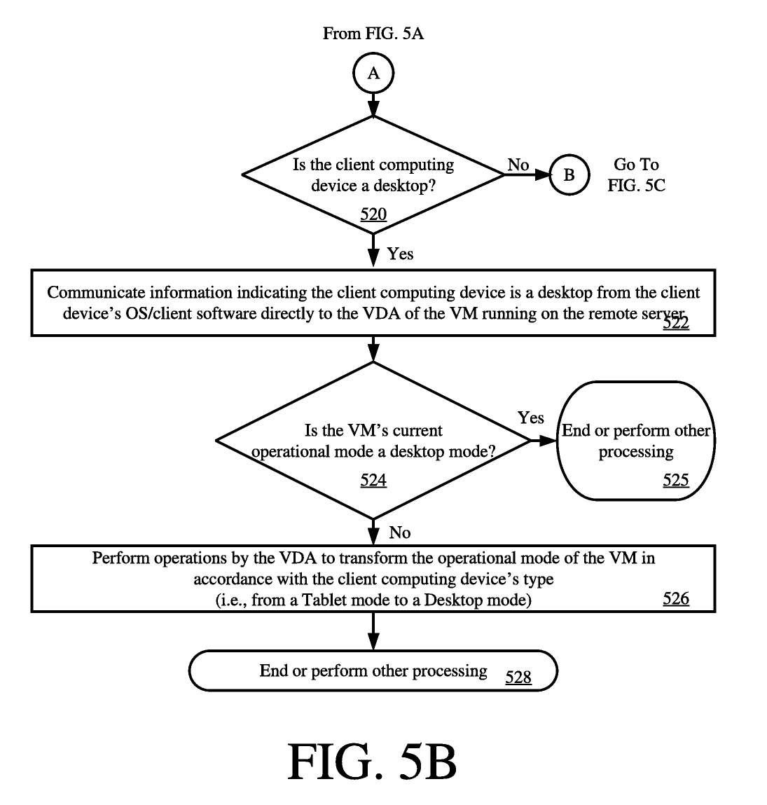

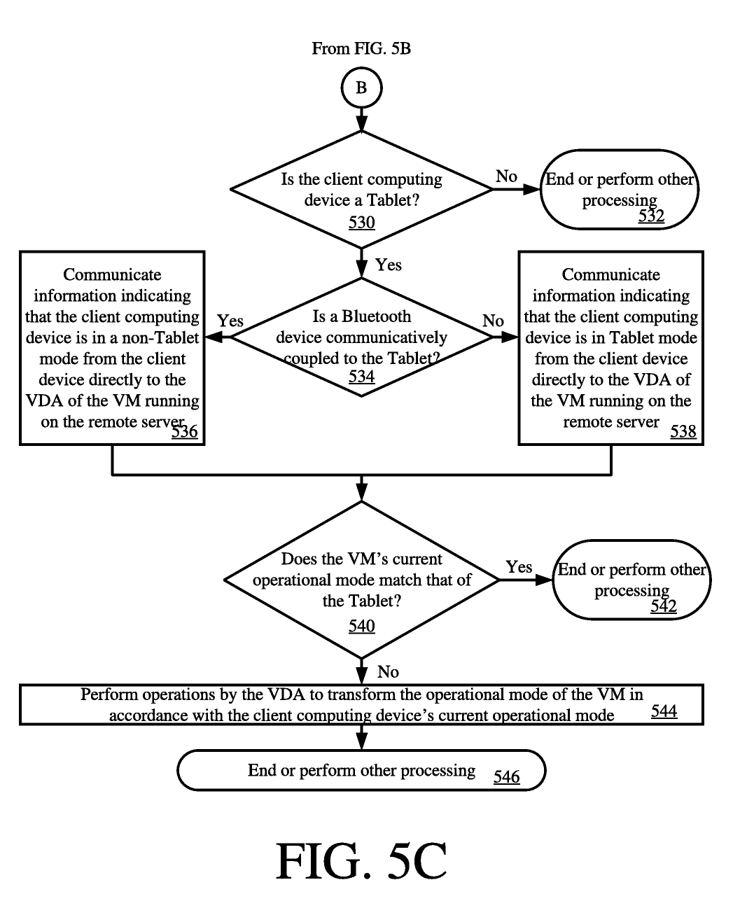

Referring now to FIG. 5, there is provided a flow diagram of an exemplary method 500 for automatically changing an operational mode of a VM (e.g., VM 206 of FIG. 2) running on a remote server (e.g., server 306 of FIG. 3). As shown in FIG. 5A, method 500 begins with 502 and continues with 504 where a client computing device (e.g., computing device 100 of FIG. 1 and/or client computing device 302 of FIG. 3) is connected to an OS's VDI (e.g., VDI 308 of FIG. 3) of a remote sever (e.g., computing device 100 of FIG. 1 and/or server 306 of FIG. 3). This connection is achieved using client software (e.g., client software 126 of FIG. 1 and/or client software 312 of FIG. 3) executing on the client device. The VDI enables the hosting of a user desktop OS within the VM running on the remote server (which may be located at a datacenter).

Thereafter, a decision is made in 506 as to whether the client computing device is a 2-in-1 device. If the client computing device is a 2-in-1 device [506:YES], then method 500 continues with 508 where an OS (e.g., OS 310 of FIG. 3) and/or the client software (e.g., client software 126 of FIG. 1 and/or 312 of FIG. 3) of the client computing device performs operations to determine the client computing device's current operational mode (i.e., a Desktop mode or a Tablet mode). This determination is based on whether an input device (e.g., input device 314 of FIG. 3 such as a keyboard) is coupled to (wired or wirelessly) the client computing device or whether a user software interaction for an operational mode change was received by the client computing device. Next in 510, the client computing device's OS (e.g., OS 310 of FIG. 3) or client software (e.g., client software 126 of FIG. 1 and/or client software 312 of FIG. 3) communicates information directly to a VDA (e.g., VDA 226 of FIG. 2) of the VM running on the remote server.

At the remoter server, a decision is made in 512 as to whether the VM's current operational mode is the same as the operational mode indicated by the received information. If the VM's current operational mode is the same as the operational mode indicated by the received information [512:YES], then method 500 continues with 508. In contrast, if the VM's current operational mode is different than the operational mode indicated by the received information [512:NO], then operations are performed by the VDA in 516 to transform the operational mode of the VM in accordance with the client computing device's mode change (e.g., from the Desktop mode to the Tablet mode). Subsequently, 518 is performed where method 500 ends or other processing is performed.

If the client computing device is not a 2-in-1 device [506:NO], then method 500 continues with 520 of FIG. 5B. As shown in FIG. 5B, 520 involves determining if the client computing device is a desktop computer. If the client computing device is a desktop computer [520:YES], then method 500 continues with 522 where the client computing device's OS (e.g., OS 310 of FIG. 3) or client software (e.g., client software 126 of FIG. 1 and/or client software 312 of FIG. 3) communicates information directly to a VDA (e.g., VDA 226 of FIG. 2) of the VM running on the remote server. The information indicates that the client computing device is a desktop computer. Upon receipt of this information, the server determines whether the VM's current operational mode is the Desktop mode. If the VM's current operational mode is Desktop mode [524:YES], then 525 is performed where method 500 ends or other processing is performed. In contrast, if the VM's current operational mode is not Desktop mode [524:NO], then 526 is performed. In 525, the VDA performs operations to transform the operational mode of the VM in accordance with the client computing device's type (e.g., from a Tablet mode to a Desktop mode). Subsequently, 528 is performed where method 500 ends or other processing is performed.

If the client computing device is not a desktop [520:NO], then method 500 continues with 530 of FIG. 5C. In 530, a decision is made as to whether the client computing device is a tablet. If the client computing device is not a tablet [530:NO], then 532 is performed where method 500 ends or other processing is involved. In contrast, if the client computing device is a tablet [530:YES], then a decision is made in 534 as to whether a Bluetooth® device is communicatively coupled to the tablet.

If a Bluetooth® device is communicatively coupled to the tablet [534:YES], then the client computing device communicates information directly to the VDA of the VM running on the remote server, as shown by 536. This information indicates that the client computing device is in a non-Tablet mode. In contrast, if a Bluetooth® device is not communicatively coupled to the tablet [534:NO], then the client computing device also communicates information directly to the VDA of the VM running on the remote server, as shown by 538. However, this information indicates that the client device is in a Tablet mode.

In response to receiving the information in 536 or 538, 540 is performed where a decision is made as to whether the VM's current operational mode matches that of the tablet. If so [540:YES], then 542 is performed where method 500 ends or other processing is performed. If not [540:NO], then 544 is performed. In 544, the VDA performs operations to transform the operational mode of the VM in accordance with the client computing device's current operational mode. Subsequently, 546 is performed where method 500 ends or other processing is performed.

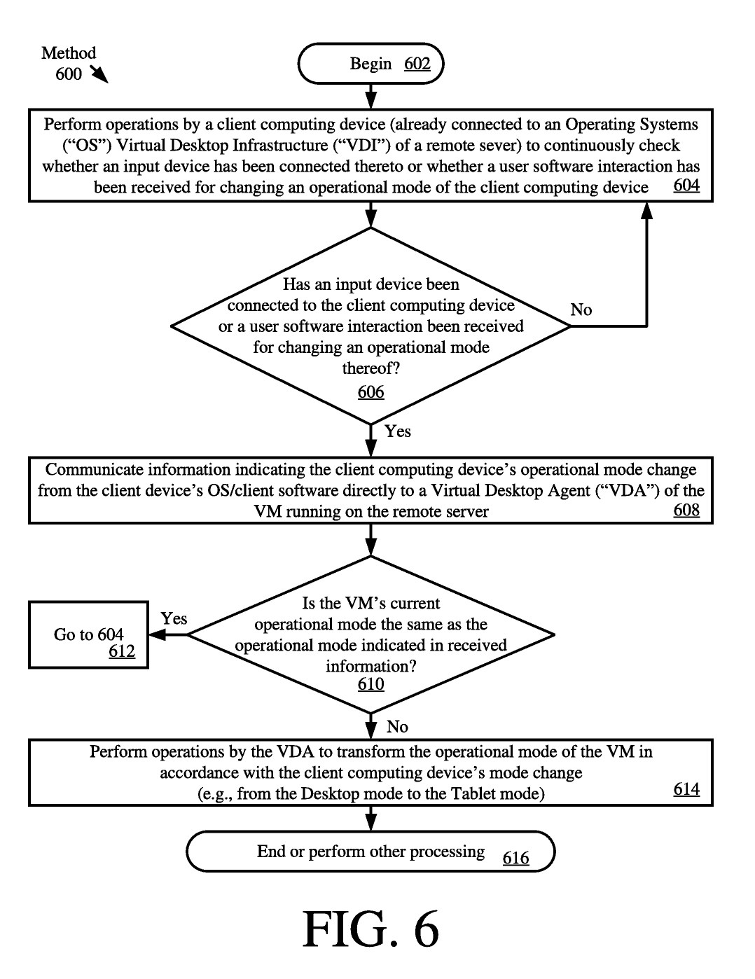

Referring now to FIG. 6, there is provided a flow diagram of an exemplary method 600 for automatically changing an operational mode of a VM (e.g., VM 206 of FIG. 2) running on a remote server (e.g., server 306 of FIG. 3). Method 600 begins with 602 and continues with 604 where operations are performed by a client computing device (already connected to an OS Virtual Desktop Infrastructure VDI of a remote sever) to continuously check whether an input device (e.g., keyboard 150 of FIG. 1 or input device 314 of FIG. 3) has been connected thereto or whether a user software interaction (e.g., a menu selection) has been received for changing an operational mode of the client computing device (e.g., computing device 100 of FIG. 1 and/or client computing device 302 of FIG. 3). If an input device has not been connected to the client computing device or a user-software interaction has not been received for changing an operational mode of the client computing device [606:NO], then method 600 returns to 604.

In contrast, if an input device has been connected to the client computing device or a user-software interaction has been received for changing an operational mode of the client computing device [606:YES], then information is communicated from the client computing device directly to the VDA (e.g., VDA 226 of FIG. 2), as shown by 608. This information indicates the client computing device's operational mode change. Next in 610, a determination is made as to whether the VM's current operational mode is the same as the operational mode indicated in the received information. If so [610:YES], method 600 returns to 604 as shown by 612. If not [610:NO], the VDA performs operations to transform the operational mode of the VM in accordance with the client computing device's mode change (e.g., from the Desktop mode to the Tablet mode), as shown by 614. Subsequently, 616 is performed where method 600 ends or other processing is performed.

All of the apparatus, methods, and algorithms disclosed and claimed herein can be made and executed without undue experimentation in light of the present disclosure. While the invention has been described in terms of preferred embodiments, it will be apparent to those having ordinary skill in the art that variations may be applied to the apparatus, methods and sequence of steps of the method without departing from the concept, spirit and scope of the invention. More specifically, it will be apparent that certain components may be added to, combined with, or substituted for the components described herein while the same or similar results would be achieved. All such similar substitutes and modifications apparent to those having ordinary skill in the art are deemed to be within the spirit, scope and concept of the invention as defined.

The features and functions disclosed above, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

We claim:

1. A method for automatically changing an operational mode of a Virtual Machine (“VM”), comprising:
detecting an operational mode change of a computing device from a first operational mode to a second operational mode in response to (a) a coupling or decoupling of an external device to/from the computing device or (b) a reception of a user-software interaction for changing the operational mode;
communicating first information indicating the computing device's operational mode change from first software of the computing device directly to a Virtual Desktop Agent (“VDA”) of the VM;
performing first operations by the VDA to determine whether a third operational mode in which the VM is currently operating is the same as the second operational mode in which the computing device is currently operating; and
performing second operations by the VDA to transform the third operational mode of the VM to the second operational mode when a determination is made that the third operational mode is different than the second operational mode.

2. The method according to claim 1, wherein the computing device is a client computing device and the VM is running on a remote server.

3. The method according to claim 2, wherein the client computing device is a 2-in-1 device.

4. The method according to claim 3, wherein the first operational mode is a Desktop mode and the second operational mode is a Tablet mode.

5. The method according to claim 3, wherein the first operational mode is a Tablet mode and the second operational mode is a Desktop mode.

6. The method according to claim 2, wherein the first software of the computing device comprises client software enabling access to a Virtual Desktop Infrastructure (“VDI”) of the remote server via a network.

7. The method according to claim 6, wherein the VDI allows virtualization software to emulate the computing device's hardware on the remote server.

8. The method according to claim 6, further comprising performing third operations by the VDA to transform the VM's operational mode in response to a connection of another computing device, that is of a type different than that of the computing device, to the VDI during a VM session.

9. The method according to claim 1, wherein the external device is an input device.

10. A method for automatically changing an operational mode of a Virtual Machine (“VM”), comprising:
performing operations by a first computing device of a first device type to establish a VM-based Virtual Desktop Infrastructure (“VDI”) session to the VM running on a remote server;
performing operations by a second computing device to connect to the VM during the VM-based VDI session, the second computing device of a second device type different than the first device type of the first computing device;
communicating information indicating the second device type from client software of the second computing device directly to a Virtual Desktop Agent (“VDA”) of the VM; and
performing operations by the VDA to transform an operational mode of the VM from a first operational mode to a second different operational mode based on the second device type.

11. A system, comprising:
a first computing device comprising a first electronic circuit programmed to
toggle an operational mode between a first operational mode and a second operational mode in response to (a) a coupling or decoupling of an external device to/from the first computing device or (b) a reception of a user-software interaction for changing the operational mode, and
communicate first information indicating a change in the operational mode directly to a Virtual Desktop Agent (“VDA”) of a Virtual Machine (“VM”);
a second computing device remotely located from the first computing device, and comprising a second electronic circuit programmed to host the VM and make the VM accessible to the first computing device via a network;
wherein the VDA determines whether a third operational mode in which the VM is currently operating is the same as the first or second operational mode in which the first computing device is currently operating, and transforms the third operational mode of the VM to the first or second operational mode when a determination is made that the third operational mode is different than the first or second operational mode.

12. The system according to claim 11, wherein the first computing device is a client computing device and the second computing device is a server.

13. The system according to claim 12, wherein the client computing device is a 2-in-1 device.

14. The system according to claim 13, wherein the first operational mode is a Desktop mode and the second operational mode is a Tablet mode.

15. The system according to claim 13, wherein the first operational mode is a Tablet mode and the second operational mode is a Desktop mode.

16. The system according to claim 12, wherein the first computing device comprises client software enabling access to a Virtual Desktop Infrastructure (“VDI”) of the remote server.

17. The system according to claim 16, wherein the VDI allows virtualization software to emulate the first computing device's hardware on the remote server.

18. The system according to claim 16, wherein the VDA further transforms the VM's operational mode in response to a connection of a third computing device, that is of a type different than that of the first computing device, to the VDI during a VM session.

19. The system according to claim 11, wherein the external device is an input device.
